(19) United States
(12) Patent Application Publication
(10) Pub. No.: US 2003/0146624 A1
(43) Pub. Date: Aug. 7, 2003

(54) Pipe joint and pipe joint structure

(76) Inventor: Yuuichi Gotoh, Owariasahi-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/282,285

(22) Filed: Oct. 28, 2002

(30) Foreign Application Priority Data
Feb. 6, 2002 (JP) 2002-029468

(51) Int. Cl. F16L 25/00; F16L 35/00

(52) U.S. Cl. 285/334.5

(57) ABSTRACT

A joint for a pipe having a flared end portion comprises (i) an inner tube portion adapted to be fitted into an inner circumference of the pipe; (ii) a joint body having a circular sealing surface extending from the inner tube portion, wherein the sealing surface is adapted to support the flared end portion of the pipe; and (iii) a securing component adapted to have the pipe inserted therethrough and to fixedly press the flared end portion against the sealing surface of the joint body, wherein the flared end portion is interposed between the sealing surface and the securing component.

### BACKGROUND OF THE INVENTION

1. Field of the Invention

The present invention relates to a joint for piping and a pipe joint structure including the structure of the joint for piping.

2. Description of the Related Art

Metal pipe joint structures conventionally known include the following: At the tip of a metal pipe, a flared end portion is formed by extending the bore diameter of the pipe. After a cap nut is placed around the metal pipe, the inner surface side of the flared end portion is placed against a joint body of a joint for piping. By tightening the cap nut against the joint body, the flared end portion of the metal pipe is fitted and deformed in such a manner that the flared end portion is collapsed between the cap nut and the joint body.

In such a connection structure, if the diameter of a metal pipe is large, great force is required for tightening, a large-sized working tool is necessary, and connecting work becomes exceedingly difficult. Additionally, as the material for the metal pipe, aluminum or flexible copper, which is plastic and deformative, needs to be used. Using steel or hard copper, there are problems in that connection becomes more difficult and tight sealing cannot be achieved.

### SUMMARY OF THE INVENTION

Given these factors, as a means of improving the sealing property in the above type of connection structure, connecting the metal contact portions of a joint for piping and a pipe together by putting a rubber packing therebetween is possible. However, even with this structure with the packing or others placed between the metal contact portions, it is extremely difficult to tightening a cap nut while maintaining the packing concentrically with the pipe, because the structure is not made to maintain the position of the packing. Consequently, the packing becomes eccentric to the pipe; hence the desired effect cannot be obtained. Additionally, coating an adhesive inside and outside the metal pipe is feasible. However, if the adhesive is coated, the adhesive coated may flow out and drip inside the joint body when being squeezed as the cap nut is tightened. The adhesive after hardened may get mixed with liquid flowing inside the pipe. For example, in the case of piping for an air-conditioning refrigerant pipe, the hardened adhesive is sucked into a compressor, taking advantage of a flow of the refrigerant, and this may destroy the compressor in some cases.

The present invention has been made in view of the above-mentioned circumstances, and can provide a joint for piping and a pipe joint structure, which are excellent in sealing property and workability.

In an embodiment, the present invention provides a joint for a pipe having a flared portion, comprising: (i) an inner tube portion adapted to be fitted into an inner circumference of the pipe; (ii) a joint body having a circular sealing surface extending from the inner tube portion, said sealing surface being adapted to support the flared end portion of the pipe; and (iii) a securing component adapted to have the pipe inserted therethrough and to fixedly press the flared end portion against the sealing surface of the joint body, wherein the flared end portion is interposed between the sealing surface and the securing component.

Further, the present invention includes but are not limited to the following embodiments:

The securing component has at least one groove for an adhesive formed on and inner circumference surface of the securing component where the inner circumference surface encloses a periphery of the pipe.

The groove is circular or spiral.

The joint further comprises a ring-shaped packing adapted to be interposed between the sealing surface of the joint body and the flared end portion of the pipe.

The securing component has threads on an inner circumference thereof and the joint body has threads on an outer circumference thereof, thereby screwing the securing component and the joint body together to secure the flared end portion between the securing component and the joint body. Alternatively, the securing component and the joint body are configured to be tightened with bolts to secure the flared end portion between the securing component and the joint body.

In another aspect, the present invention provides a pipe joint structure comprising: (i) a pipe having a flared end portion; (ii) a joint comprising: (a) an inner tube portion fitted into an inner circumference of the pipe; (b) a joint body having a circular sealing surface extending from the inner tube portion, said sealing surface supporting the flared end portion of the pipe; and (c) a securing component having the pipe inserted therethrough and fixedly pressing the flared end portion against the sealing surface of the joint body, wherein the flared end portion is interposed between the sealing surface and the securing component.

Further, the present invention includes but are not limited to the following embodiments:

The pipe joint structure further comprises an adhesive between a periphery of the pipe and an inner circumference surface of the securing component where the periphery of the pipe is surrounded by the inner circumference surface of the securing component.

The securing component has at least one groove for the adhesive formed on the inner circumference surface of the securing component.

The groove is circular or spiral.

The pipe joint structure further comprises a ring-shaped packing interposed between the sealing surface of the joint body and the flared end portion of the pipe.

The securing component has threads on an inner circumference thereof and the joint body has threads on an outer circumference thereof, thereby screwing the securing component and the joint body together to secure the flared end portion between the securing component and the joint body. Alternatively, the securing component and the joint body are configured to be tightened with bolts to secure the flared end portion between the securing component and the joint body.

The pip is made of steel or hard copper.

For purposes of summarizing the invention and the advantages achieved over the prior art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention.

FIG. 1 shows a front view of the joint for piping and the pipe joint structure in Embodiment 1.

FIG. 2 shows a cross section of the same.

FIG. 3 shows an enlarged partial cross-section of the same when the connection is completed.

FIG. 4 shows a front view of the joint for piping and the pipe joint structure in Embodiment 2.

FIG. 5 shows a cross section of the same.

FIG. 6 shows an enlarged partial cross-section of the same when the connection is completed.

FIG. 7 shows a front view of the joint for piping and the pipe joint structure in Embodiment 3.

FIG. 8 shows a cross section of the same.

FIG. 9 shows a side view of the same.

FIG. 10 shows an enlarged partial cross-section of the same when the connection is completed.

In the figures, symbols indicate the following: 10, 60: Joint for piping; 11, 61: Joint body; 15, 65: Inner tube portion; 16, 66: Sealing surface; 20, 70: Securing component; 23: Groove; 30: Pipe; 31: Flared end portion; 40: Ring packing (elastic component); 50: Adhesive.

### DETAILED DESCRIPTION OF THE PREFERRED EMBODIMENT

The present invention can be carried out in various ways and exhibit various advantages. For example, according to an embodiment, when putting a packing such as an elastic component between the flared end portion of the pipe and the sealing surface of the joint body, the elastic component arranged in a position to be held tightly is held always in a position where it should be by the inner tube portion, preventing de-centering of the elastic component with the pipe during assembling work. Additionally, when coating an adhesive on a contact portion, flowing or leaking of the coated adhesive to the inside or the outside of the pipe is prevented by the inner tube portion.

In other words, when connecting a pipe and a joint for piping, by applying an elastic component or coating an adhesive to or around the sealing surface of the pipe, the inner tube portion of the joint body is fitted into the inner circumference side of the pipe. At this time, the proper position of the joint body with the pipe is maintained by being guided into the inner circumference side. When the inner tube portion of the joint body is inserted and fitted into the inner part of the pipe, a securing component which has been attached to the pipe is fixed to the joint body. At this time, the flared end portion of the pipe is pressed against the sealing surface of the joint body through the elastic component or the adhesive, and by this pressing, the pipe and the joint for piping are adhered closely to each other. During the above-mentioned work, the elastic component or the adhesive does not leak out to the piping as mentioned above and is held tightly and securely in a proper position between the sealing surface and the flared end portion.

As described above, the joint for piping and the pipe joint structure according to the present invention enable to hold tightly the elastic component or the adhesive easily in the proper position between the sealing surface and the flared end portion, which is conventionally difficult to be used due to the inner tube portion, and excellent effect that the pipe joint structure with a high degree of sealing can be obtained is achieved with conducting simple work.

It is unavoidable that deformation from a perfect circle is caused to a pipe and a joint for piping when connecting them. When deformation is caused, even a slight deformation can produce an uneven gap. If an adhesive is used, the adhesive does not spread evenly, causing adhesive failure in a circumference direction of the pipe.

Consequently, in an embodiment of the present invention, as mentioned above, a circular groove is formed in the inner circumference surface of a portion letting the pipe through of a securing component. In-this case, because the adhesive coated spreads out to allover the groove by a capillary phenomenon, an area with adhesive failure becomes small, further improving sealing of the pipe.

### EXAMPLE

The present invention will be explained with reference to figures. However, the present invention is not limited to the figures.

<Embodiment 1>

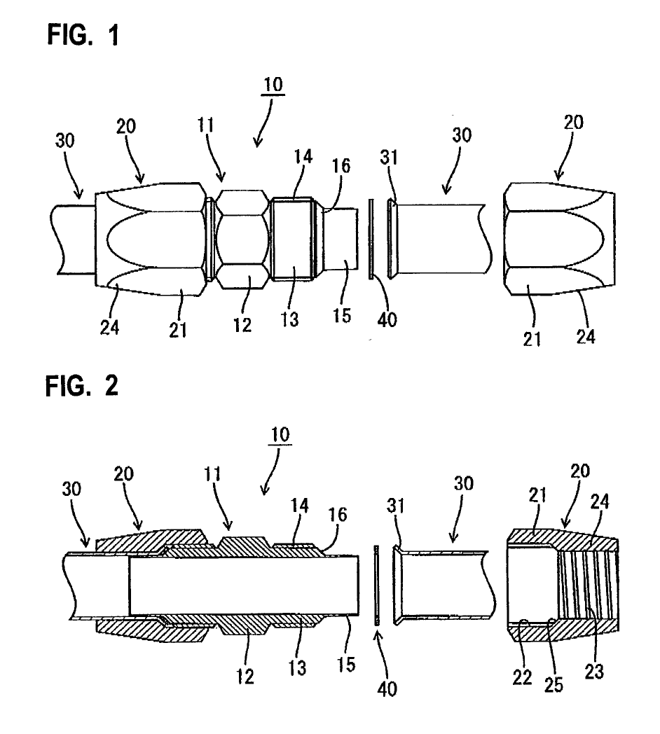

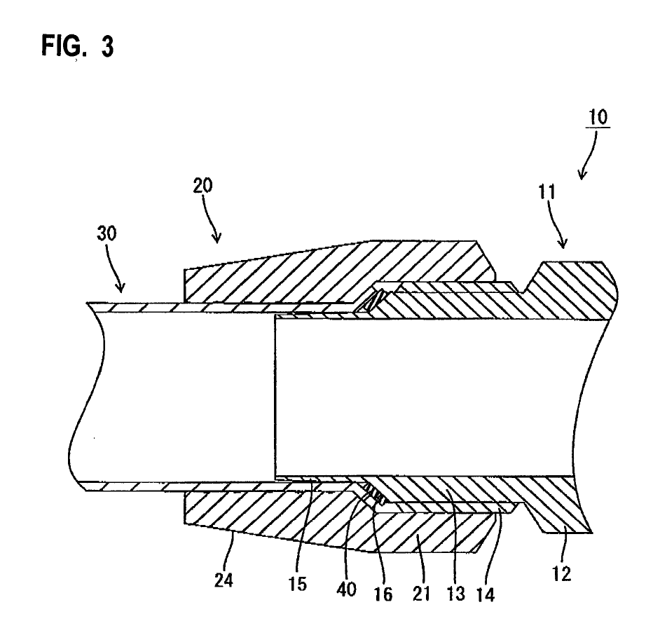

An embodiment of the present invention is described in detail by referring to FIG. 1 or FIG. 3.

FIG. 1 shows a front view of the joint for piping and the pipe joint structure of this embodiment for carrying out the present invention. FIG. 2 shows a cross section of the same and FIG. 3 shows an enlarged partial cross-section of the pipe in a connected position. This joint for piping 10 is formed using a metal, for example, iron, etc. and comprises a joint body 11 which concentrically links two pipes 30 with the same diameter, each of which has a flared end portion 31 where the bore diameter of the pipe is extended at the tip, and a pair of securing components 20 which secure the linked pipes 30 with the joint body 11 respectively.

The joint body 11 is tubular, and a thick portion 12 having a hexagonal external section is formed on the longitudinal peripheral wall of its center portion. The peripheral walls on both sides of this thick portion 12 functions as a portion 13 being secured on which a securing component 20 (to be mentioned later) is fixed. On the exterior surface of the portion 13 on which the securing component 20 is fixed, a screw groove 14 for fitting with the screw portion 22 of the securing component 20 is formed. The end portion, which is further from the portion 13 of the joint main body 20, is made as an inner tube portion 15 formed with the diameter fitting into the inner circumference side of the end of the pipe 30. A border between the portion 13 and the inner tube portion 15 is formed as an inclined plane tapering off toward the inner tube portion 15 and functions as a sealing surface 16 to which the flared end portion 31 of the pipe 30 to be linked is applied.

The securing component 20 also has a tubular shape through which the pipe 30 can be inserted. One of its ends is formed as a securing portion 21, the external section of which is hexagonal, and on the inner circumference side, the screw portion 22 for fitting with the screw groove 14 of the portion 13 is formed.

On the other end, the inner surface of the end is formed with a diameter fitting into the outer circumference side of the pipe 30 to function as a guide 24 with a circular groove 23 formed along the inner surface. Furthermore, a border on the inner surface side between the securing portion 21 and the guide portion 24 is formed as an inclined plane tapering off toward the guide portion 24 and functions as a pressing portion 25 for pressing the flared end portion 31 of the pipe 30 against the sealing surface 16.

Additionally, in this embodiment, a ring packing 40 made of, for example, Teflon® or nylon resin with a diameter fitting with the outer circumference of the inner tube 15 of the joint body 11 is used.

A method for connecting two pipes 30 using this type of joint for piping is described below. First, one of the pipes 30 is inserted in the securing component 20 of the joint for piping 10 and the ring packing 40 is fitted with the outer circumference side of the inner tube portion 15 of the joint body 11. In this position, the inner tube portion 15 of the joint body 11 is inserted in the pipe 30 and is moved to the position wherein the sealing surface 16 of the joint body 11 is applied to the flared end portion 31 of the pipe through the ring packing 40. At this time, because the inner tube portion 15 advances along the inner circumference wall of the pipe 30 until the inner part of the pipe 40, fitting of the joint body 11 and the pipe 30 is maintained in a proper position all the time. Additionally, because the position of the ring packing 40 in the diameter direction is maintained by the inner tube portion 15, no displacement and movement is caused by de-centering during fitting work.

While maintaining the securing component 20 attached to the pipe 30 in a proper position using its guide portion 24, the securing component 20 is moved to the side of the joint body 11 and the screw portion 22 is screwed in the screw groove 14 of the portion 13 on which the securing component 20 is fixed. When the screw portion 22 is screwed in the inner part of the screw groove 14, the pressing portion 25 of the securing component 20 contacts the flared end portion 31 of the pipe 30, and with the securing component 20 being screwed in further, the flared end portion 31 is strongly pressed against the sealing surface 16 by the pressing portion 25, and the joint body 11 is securely fixed with the pipe 30. At this time, the ring packing 40 lies between the flared end portion 31 and the sealing surface 16. Because the ring packing 40 is being collapsed by the two, the joint body 11 and the pipe 30 are connected so that high degree of sealing is maintained.

Additionally, the pipe 30 on the other side is connected with the joint for piping 10 by following the same procedure as described above.

In this manner, the joint for piping 10 in this embodiment is able to provide a pipe joint structure excellent in sealing property by conducting simple work which comprises fitting the inner tube portion 15 of the joint body 11 into the pipe 30 and fixing the securing component 20.

<Embodiment 2>

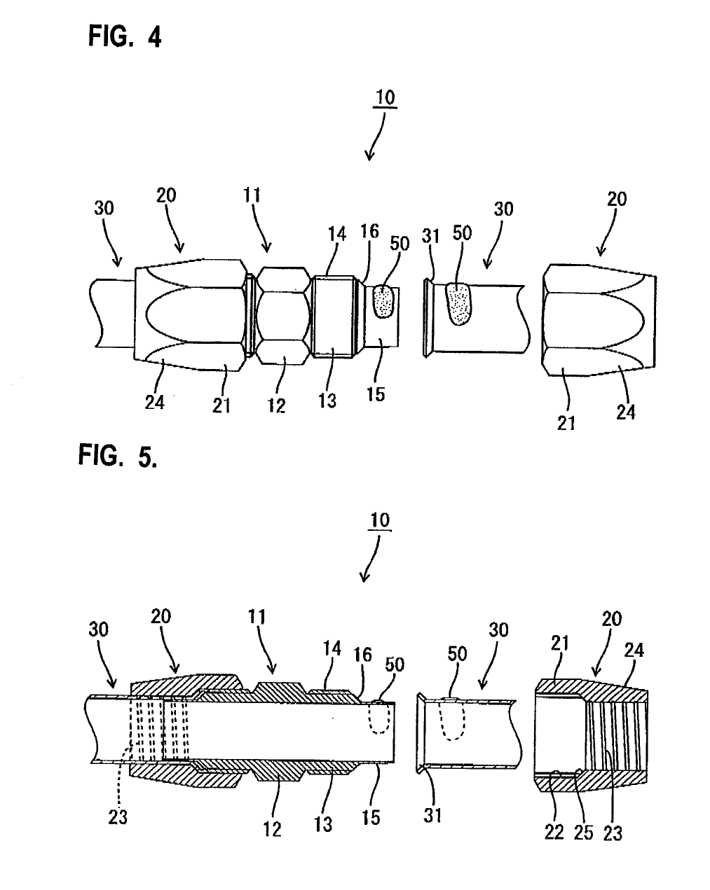

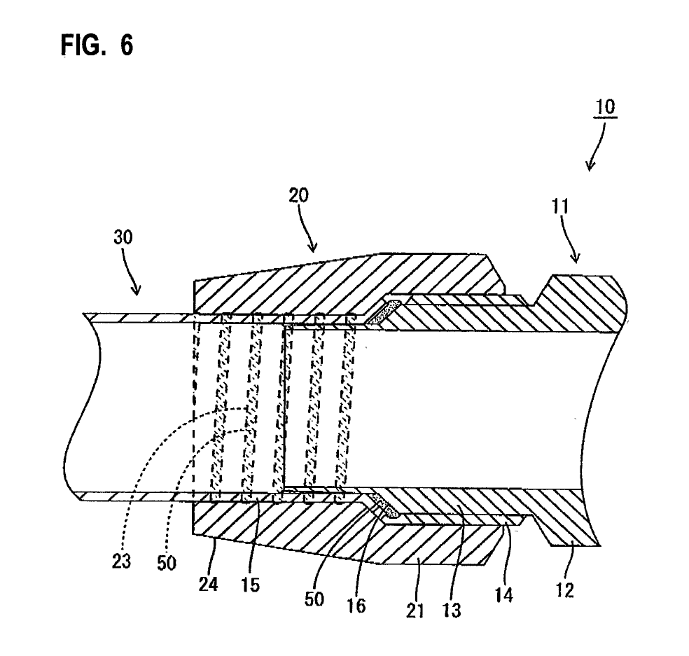

A joint for piping and a pipe structure in this embodiment are shown in FIG. 4 or FIG. 6. The joint for piping 10 in this embodiment has the same configuration as that of Embodiment 1 described above. It, however, differs because an adhesive 50 is used in place of the ring packing 40.

In this embodiment, when connecting two pipes 30, one of the pipes 30 is inserted in the securing component 20 of the joint for piping 10 and an adhesive 50, e.g., an anaerobic adhesive, a heat-resisting epoxy adhesive, etc. is coated around the sealing surface 16 of the inner tube portion of the joint body 11 and an area near the tip on the outer circumference side of the pipe 30 (See FIG. 4.). In this position, the inner tube portion 15 of the joint body 11 is inserted in the pipe 30 and is moved to the position where the sealing surface 16 of the joint body 11 is applied to the flared end portion 31 of the pipe. The adhesive 50 coated near the sealing surface 16 is pushed up and spread onto the sealing surface 16 and is wedged between the sealing surface 16 and the flared end portion 31, gluing and fixing the two. Additionally, the adhesive 50 coated near the tip of the pipe 30 is spread out by the inner surface of the guide portion 24 when the screw portion 22 of the securing component 20 is screwed in the screw groove 14 of the joint body, filling inside the screw groove 23 nearly with no space between by a capillary phenomenon (See FIG. 6.). By this, the securing component 20 and the pipe 30 are securely adhered and fixed.

In this manner, by this embodiment, the pipe joint structure excellent in sealing property can be obtained by only conducting simple work. Additionally, with the configuration that the inner tube portion is provided for the joint body, the adhesive coated does not flow out or run off.

<Embodiment 3>

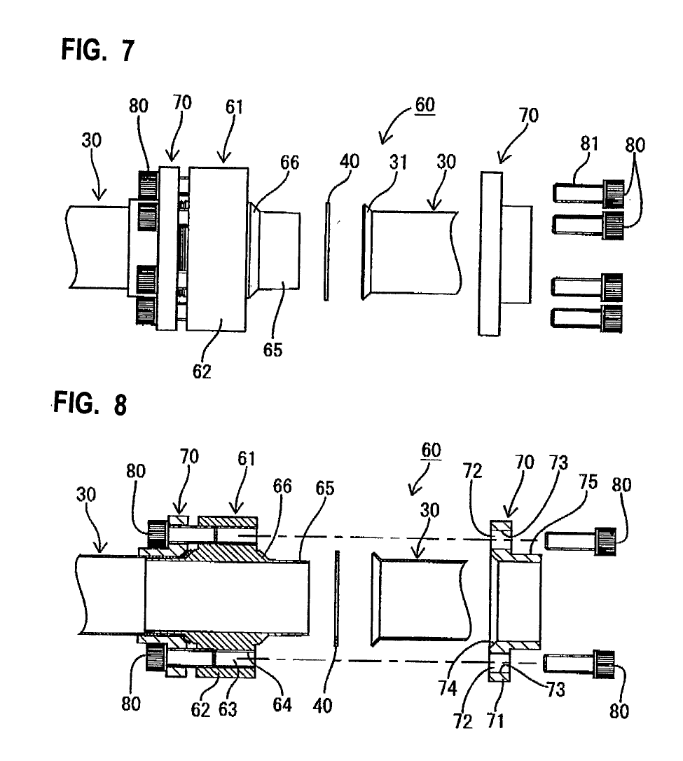

A cross section of a pipe joint structure in Embodiment 3 is shown in FIG. 7 or FIG. 10. The joint for piping 60 in this embodiment is also to connect two tubular pipes 30 with the same diameter concentrically. The securing structure of the above-mentioned embodiments, however, is altered.

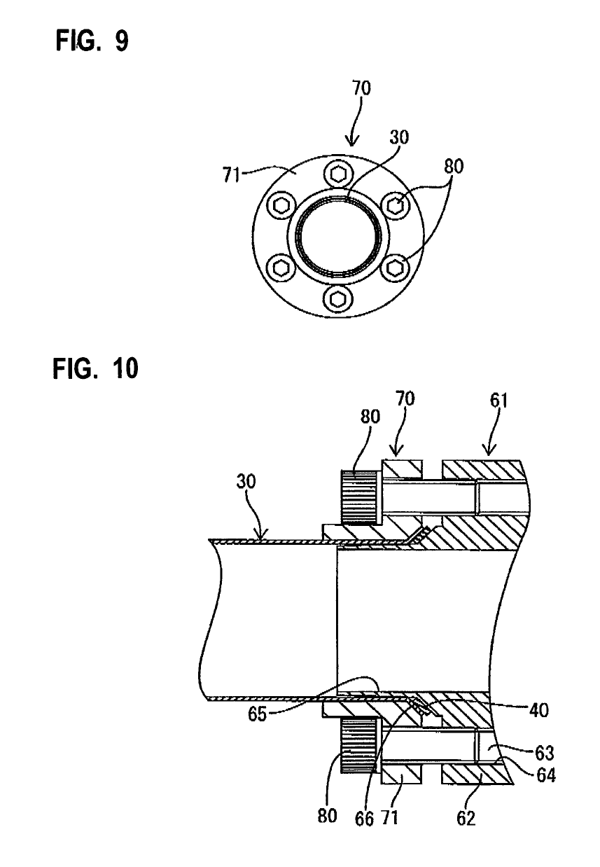

The joint for piping 60, in the same way as the joint for piping 10 in the above-mentioned embodiments, is formed of a metal, e.g., iron, etc. The joint for piping 60 comprises a joint body 61 linking two pipes 30 and a pair of securing components 70 used for tightening and fixing these pipes 30 with the respective ends of the joint body 61. The joint body 61 is tubular and a thick flange portion 62 protruding in the direction of the diameter is formed on the longitudinal peripheral wall of its center portion. In this flange portion 62, six screw holes 63 in which lock-screws 80 mentioned later are screwed in are formed at even intervals (See FIG. 9.). On the inner surface of each of these screw holes 63, a screw groove 64 fitting with the screw portion 81 of the lock-screw 61 is formed. Additionally, both ends of the joint body 61 function as the inner tube portion 65 formed with a diameter fitting into the inner circumference side of the end of the pipe 30. Near the base of the flange portion 62, an inclined surface 66 going toward the side of the inner tube portion 65, which is applied to the flared end portion 31 of the pipe 30, is formed as a sealing surface 66.

A securing component 70 and the pipe 30 have a short tubular shape which can be inserted through. At one end, a flange portion 71 with nearly the same diameter as that of the flange portion 62 of the above-mentioned joint body 61 is formed. In this flange portion 71, screw holes 72 for screwing in lock-screws 80 are formed in respective positions corresponding to the screw holes 63 in the above-mentioned flange portion 62. In the inner surface of these screw holes 72, screw grooves 73 are formed respectively. Furthermore, an opening end portion on the side of the flange portion 71 is pushed and expanded in an inclined-surface shape following the shape of the flared end portion 31 of the pipe 30 to be inserted in it and functions as a pressing portion 74 for pressing the flared end portion 61 against the sealing surface 66. The other end functions as a guide portion 75.

Additionally, in this embodiment, in the same manner as used for the above-mentioned Embodiment 1, a ring packing 40 fitting with the outer circumference side of the inner tube portion 65 of the joint body 61 is used.

The joint for piping in this embodiment is as described above. A method for connecting two pipes 30 using this joint for piping 60 is described below. First, a pipe 30 is inserted in the securing component 70 of the joint for piping 60 and a ring packing 90 is fitted with the outer circumference side of the inner tube portion 65 of the joint body 61. In this position, the inner tube portion 65 of the joint body 61 is fitted inside the pipe 30, and is moved to the position in which the flared end portion 31 of the pipe is applied to the sealing surface 66 of the joint body 61 through the ring packing 40. While maintaining the securing component 70 attached to the pipe 30 in a proper position using its guide portion 75, the securing component 70 is moved toward the joint body 61, and by screwing six lock-screws 80 respectively in screw holes 72 of the securing component 70 and screw holes 63 of the joint body 61 by equal force, the flared end portion 31 is pressed strongly against the sealing surface 66 by the pressing portion 73 and the pipe 30 and the joint body 61 are securely fixed. At this time, because the securing component 70 is held always in a proper position by the guide portion 75, lock-screws 80 can be screwed in easily. Additionally, because the ring packing 40 lies between the flared end portion 31 and the sealing surface 66 and the ring packing 40 is being crushed by the two, the joint body 61 and the pipe 30 are connected to maintain high degree of sealing.

In this manner, in the joint for piping 60 in this embodiment, by conducting simple work to fit the inner tube portion 65 of the joint for piping 60 into the pipe 30 and to fix the securing component 70 by the lock-screws 80, the pipe joint structure excellent in sealing effect can be obtained

<Other Embodiments>

The present invention is not limited to the embodiments described above and by figures. For example, the following embodiments are included in a technical scope of the present invention, and further those other than the above-mentioned can be carried out by altering them in various manners without departing from the scope of the invention.

(1) In the above-mentioned embodiments, the joints for piping 10 and 60 concentrically connect two pipes 30 having the same diameter. Not limiting to this type of application, the invention, for example, can be applied to connecting a metal pipe directly with equipment such as a tank, etc. Additionally, it can be applied to connecting two different kinds of pipes having different diameters. Needless to say, it can be applied to an elbow joint as well, which is bent to connect pipes.

(2) In the above-mentioned embodiments, pipes 30 having the flared end portion 61 where the tip of the pipe is extended and opened at a slant are used. Not limiting to these, for example, the invention can be applied to the pipes having such structures with the flared end portion at the tip is bent and opened at right angles or with the end portion formed thickly, etc.

(3) Any kinds of adhesives with adhesive force suitable for a pipe can be used. Preferably, an anaerobic adhesive that can airtightly join a metal pipe is used. For example, an adhesive, ThreeBond 1300 series (manufactured by Three Bond Co.), whose main component is metaacrylate, can be used. Depending on the intended use of the pipe, the adhesive may be selected to be tolerant to a temperature range of −40° C./−104° F. to 150° C./302° F. and show longitudinal shear strength of more than 100 Kgf/cm².

(4) The pipe can be made of any material such as plastic and metal including copper (e.g., hard copper) and steel. The joint itself can be made of the same material as or a different material from the pipe. Preferably, the joint is made of a material which is as hard as or harder than the material of the pipe.

(5) The thickness of the inner tube portion may be, for example, approximately 1/2 to 3/4 of that of the pipe. Connection can be done suitably if a thickness of a pipe to be connected is, for example, approximately 0.5 to 2 mm (in most cases, 1 to 1.5 mm) and its diameter is, for example, approximately 10 to 80 mm (in most cases 20 to 50 mm). The outer diameter of the flared end portion may be approximately 5-20% larger than the outer diameter of the pipe. The angle of the flared end portion may be 10°-90°, preferably 30°-60° with respect to the pipe periphery.

(6) The depth of the grooves formed on an inner circumference of the securing component maybe 0.1-2 mm (including 0.5-1 mm), and its width may be 0.5-5 mm (including 1-2 mm).

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A joint for a pipe having a flared end portion, comprising:
an inner tube portion adapted to be fitted into an inner circumference of the pipe;
a joint body having a circular sealing surface extending from the inner tube portion, said sealing surface being adapted to support the flared end portion of the pipe; and
a securing component adapted to have the pipe inserted therethrough and to fixedly press the flared end portion against the sealing surface of the joint body, wherein the flared end portion is interposed between the sealing surface and the securing component.

2. The joint according to claim 1, wherein the securing component has at least one groove for an adhesive formed on an inner circumference surface of the securing component where the inner circumference surface encloses a periphery of the pipe.

3. The joint according to claim 2, wherein the groove is circular.

4. The joint according to claim 2, wherein the groove is spiral.

5. The joint according to claim 1, further comprising a ring-shaped packing adapted to be interposed between the sealing surface of the joint body and the flared end portion of the pipe.

6. The joint according to claim 1, wherein the securing component has threads on an inner circumference thereof and the joint body has threads on an outer circumference thereof, thereby screwing the securing component and the joint body together to secure the flared end portion between the securing component and the joint body.

7. The joint according to claim 1, wherein the securing component and the joint body are configured to be tightened with bolts to secure the flared end portion between the securing component and the joint body.

8. A pipe joint structure comprising:
(i) a pipe having a flared end portion;
(ii) a joint comprising:
an inner tube portion fitted into an inner circumference of the pipe;
a joint body having a circular sealing surface extending from the inner tube portion, said sealing surface supporting the flared end portion of the pipe; and
a securing component having the pipe inserted therethrough and fixedly pressing the flared end portion against the sealing surface of the joint body, wherein the flared end portion is interposed between the sealing surface and the securing component.

9. The pipe joint structure according to claim 8, further comprising an adhesive between a periphery of the pipe and an inner circumference surface of the securing component where the periphery of the pipe is surrounded by the inner circumference surface of the securing component.

10. The pipe joint structure according to claim 9, wherein the securing component has at least one groove for the adhesive formed on the inner circumference surface of the securing component.

11. The pipe joint structure according to claim 10, wherein the groove is circular.

12. The pipe joint structure according to claim 10, wherein the groove is spiral.

13. The pipe joint structure according to claim 8, further comprising a ring-shaped packing interposed between the sealing surface of the joint body and the flared end portion of the pipe.

14. The pipe joint structure according to claim 8, wherein the securing component has threads on an inner circumference thereof and the joint body has threads on an outer circumference thereof, thereby screwing the securing component and the joint body together to secure the flared end portion between the securing component and the joint body.

15. The pipe joint structure according to claim 8, wherein the securing component and the joint body are configured to be tightened with bolts to secure the flared end portion between the securing component and the joint body.

16. The pipe joint structure according to claim 8, wherein the pip is made of steel or hard copper.
